(19) United States
(12) Patent Application Publication
(10) Pub. No.: US 2011/0274934 A1
(43) Pub. Date: Nov. 10, 2011

(54) PRIMER SILICONE COMPOSITION AND TREATED PAPER OR FILM FOR RELEASE PAPER OR FILM

(76) Inventors: Kenji YAMAMOTO, Annaka-shi (JP); Shunji Aoki, Annaka-shi (JP)

(21) Appl. No.: 13/102,136

(22) Filed: May 6, 2011

(30) Foreign Application Priority Data
May 7, 2010 (JP) 2010-107227

(51) Int. Cl. B32B 29/00; C08J 7/18; C09D 183/04

(52) U.S. Cl. 428/447; 524/588; 427/515

(57) ABSTRACT

A silicone primer is provided comprising an adhesion-providing component which is an alkenyl-containing siloxane of specific structure and/or a compound containing a substituent group having a functional group capable of radical reaction upon exposure to heat and/or UV and a substituent group having a group capable of reaction with alkenyl and/or SiH group. A release paper or film is prepared by coating the silicone primer on a paper or plastic film substrate, exposing it to UV to form a primer layer, overlaying the primed surface with a release silicone composition, and curing the composition.

### CROSS-REFERENCE TO RELATED APPLICATION

This non-provisional application claims priority under 35 U.S.C. §119(a) on Patent Application No. 2010-107227 filed in Japan on May 7, 2010, the entire contents of which are hereby incorporated by reference.

### TECHNICAL FIELD

This invention relates to a primer silicone composition and a paper or film substrate treated therewith, suited for the preparation of release paper or film having improved adhesion.

### BACKGROUND ART

It is well known from the past that release liners having release properties relative to sticky materials, typically pressure-sensitive adhesives are prepared by forming a cured coating having release properties on the surface of substrates such as paper, laminated paper and plastic film. Among the materials used for forming a cured coating having release properties are silicone compositions. For example, JP-A S62-86061 discloses a silicone composition comprising an alkenyl-containing organopolysiloxane, an organohydrogenpolysiloxane, and a platinum base compound.

Silicone compositions of this type are still predominant at the present because of their cure behavior and pot life. However, a problem has been pointed out that the adhesion between the cured coating and the substrate is not regarded sufficient. This poses limitation on the type of substrate that can be coated and necessitates pretreatment of the substrate.

Under the recent trend of available substrates, the use of plastic film substrates is increasing because of uniform and stable quality, high smoothness, and film thinness. As a wide variety of substrates are now available in the market, the requirement to improve the adhesion of silicone compositions to substrates becomes more desirable than ever.

Proposals for improving adhesion have also been made from the side of silicone compositions. For example, one attempt to use more adhesive materials includes blending of organic resins and addition of silane coupling agents. However, this attempt is utilized only under limited conditions because release properties are otherwise degraded. Another method is to modify the base polymer structure of the silicone composition. Base polymers having a branched structure containing RSiO_{3/2} units are disclosed in JP-A S63-251465, JP-B H03-19267, JP-A H09-78032, and JP-A H11-193366. This method is mainly intended for light release upon high-speed peeling and for effective cure while some improvement in adhesion is achieved as a secondary effect. Also JP-A 2000-169794 and JP-A 2000-177058 propose the combined use of a solvent type silicone composition and a solventless silicone composition, thereby achieving the effect of reducing peeling speed dependence without modifying the base polymer structure. With respect to adhesion, this proposal does not surpass the existing solvent type silicone compositions.

As discussed above, there is available in the art no appropriate technique capable of improving the adhesion of a silicone composition without affecting the release properties thereof.

### CITATION LIST

Patent Document 1: JP-A S62-86061
Patent Document 2: JP-A S63-251465
Patent Document 3: JP-B H03-19267
Patent Document 4: JP-A H09-78032
Patent Document 5: JP-A H11-193366
Patent Document 6: JP-A 2000-169794
Patent Document 7: JP-A 2000-177058

### SUMMARY OF INVENTION

An object of the invention is to provide a primer silicone composition which forms a primer layer on a surface of a substrate such as paper or plastic film and allows a release silicone composition to be coated and cured thereon to form a cured coating of the release silicone composition tenaciously adherent to the substrate surface, yielding a release paper or film. Another object is to provide a treated paper or film substrate which has been treated with the primer silicone composition.

The inventors have found that a composition comprising an adhesion-providing component which is an alkenyl-containing siloxane of specific structure and/or a compound containing a substituent group having a functional group capable of radical reaction upon exposure to heat and/or UV and a substituent group having a group capable of reaction with alkenyl and/or SiH group is useful as a primer when a release silicone composition is coated and cured onto a paper or plastic film substrate to form a release paper of film because the primer layer helps the cured coating of the release silicone composition adhere to the substrate surface. As opposed to the prior art techniques of improving adhesion at more or less sacrifice of release properties, the use of the primer can improve the adhesion of a release silicone composition without substantial impact on release properties.

Accordingly, the invention provides a primer silicone composition, a treated paper or film substrate, and a release paper or film, as defined below.

In one aspect, the invention provides a primer silicone composition which is, on use, coated on a paper or plastic film substrate and exposed to UV to form a primer layer which will be overlaid with a cured coating of a release silicone composition to form a release paper or film, the primer silicone composition comprising (A) an adhesion-providing component which is (A1) an organopolysiloxane containing at least two silicon-bonded alkenyl-containing substituent groups in a molecule, having an alkenyl content of 0.3 to 2.0 mol/100 g, and having a structure that two siloxane units in which the alkenyl-containing substituent group is bonded to silicon atom are linked directly or via up to 3 intervening siloxane units in which said substituent group is not bonded to silicon atom, the organopolysiloxane having a viscosity of less than 0.04 Pa-s at 25° C., and/or (A2) a compound containing in a molecule at least one substituent group of 2 to 10 carbon atoms having a carbon-carbon unsaturated bond (double or triple bond) as functionality and at least one substituent group having a group capable of addition reaction and/or condensation reaction with an alkenyl and/or SiH group, and (B) an amount of an optional organic solvent.

In a preferred embodiment, component (A1) is an organopolysiloxane represented by the compositional formula (1) having a structure of the general formula (2), and having an average degree of polymerization of 2 to 50.

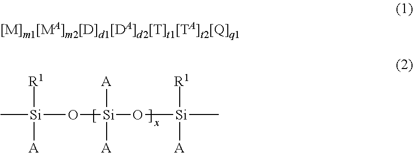

Herein R¹ is an alkenyl-containing substituent group of 2 to 10 carbon atoms, A is R² or a siloxane residue bonded via an oxygen atom and selected so as to meet formula (1), two A groups connected to one silicon atom may form a cyclic structure as —O(SiR²₂O)_{y}—, R² is a substituted or unsubstituted monovalent hydrocarbon group of 1 to 10 carbon atoms, x is an integer of 0 to 3, y is an integer selected such that the organopolysiloxane of formula (1) may have an average degree of polymerization of 2 to 50.

M, M^{A}, D, D^{A}, T, T^{A}, and Q are siloxane units as defined below, O_{1/2} denoting that adjacent siloxane units are linked via an oxygen atom,

M and M^{A} each are:

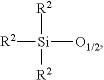

with the proviso that at least one R² in M^{A} is R¹,
D and D^{A} each are:

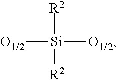

with the proviso that at least one R² in D^{A} is R¹,
T and T^{A} each are:

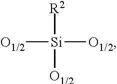

with the proviso that R² in T^{A} is R¹,

### Q is:

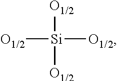

m1, m2, d1, d2, t1, t2, and q1 are numbers satisfying the equations:

t1+t2+2×q1≦m1+m2≦2+t1+t2+2×q1

0≦d1+d2≦48, 0≦t1+t2≦30, 0≦q1≦20,

0.25≦(m2+d2+t2)/(m1+m2+d1+d2+≦t1+t2+q1)≦1.

Preferably, x in formula (2) is 0 or 1.

In a preferred embodiment, component (A1) is a compound of linear or branched siloxane structure having the general formula (3) or (4).

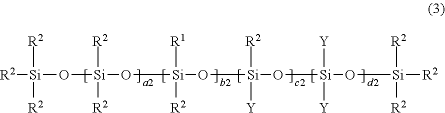

Herein R¹ and R² are as defined above, Y is a group of the following formula (3a):

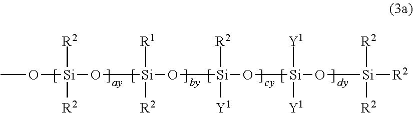

wherein R¹ and R² are as defined above, Y¹ is a group of the following formula (3b):

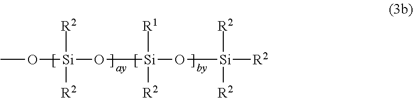

wherein R¹ and R² are as defined above, a2, b2, ay, and by each are an integer of 0 to 48, c2 and cy each are an integer of 0 to 30, d2 and dy each are an integer of 0 to 20, formulae (3), (3a) and (3b) each denote a random structure and include at least one structure that two siloxane units in which the alkenyl-containing substituent group Fe is bonded to silicon atom are linked directly or via up to 3 intervening siloxane units in which R¹ is not bonded to silicon atom.

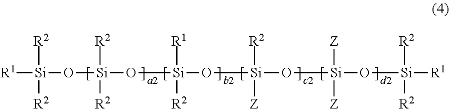

Herein R¹ and R² are as defined above, Z is a group of the following formula (4a):

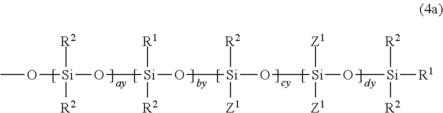

wherein R¹ and R² are as defined above, Z¹ is a group of the following formula (4b):

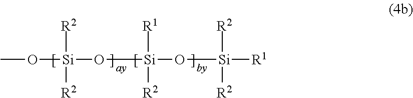

wherein R¹ and R² are as defined above, a2, b2, ay, and by each are an integer of 0 to 48, c2 and cy each are an integer of 0 to 30, d2 and dy each are an integer of 0 to 20, formulae (4), (4a) and (4b) each denote a random structure and include at least one structure that two siloxane units in which the alkenyl-containing substituent group R¹ is bonded to silicon atom are linked directly or via up to 3 intervening siloxane units in which R¹ is not bonded to silicon atom.

In another preferred embodiment, component (A1) is a compound of cyclic siloxane structure having the general formula (5).

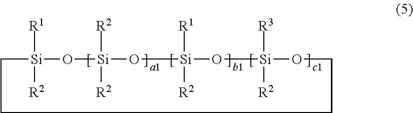

Herein R¹ and R² are as defined above, R³ is a substituent group having an OH or SiH group as functionality or a substituted or unsubstituted monovalent hydrocarbon group of 1 to 10 carbon atoms free of aliphatic unsaturation, a1 is 0 or 1, b1 is an integer of 1 to 6, c1 is an integer of 0 to 5, and a1+b1+c1 is an integer of at least 2.

Further preferably, in component (A2), the substituent group having a carbon-carbon unsaturated bond (double or triple bond) is a substituent group having alkenyl, alkynyl, acryloyloxy or methacryloyloxy, and the substituent group having a group capable of addition reaction and/or condensation reaction with an alkenyl and/or SiH group is a substituent group having a SiH, OH or alkenyl group as functionality.

Also preferably, in component (A2), the substituent group having a carbon-carbon unsaturated bond (double or triple bond) is a substituent group of 2 to 10 carbon atoms having alkynyl, acryloyloxy or methacryloyloxy, and the substituent group having a group capable of addition reaction and/or condensation reaction with an alkenyl and/or SiH group is a substituent group having a SiH, OH or alkenyl group as functionality.

In a preferred embodiment, component (A2) is a compound containing a divalent structural unit having the general formula (6-1), a compound containing divalent structural units having the general formulae (6-2) and (6-3), a compound of cyclic structure having the general formula (7-1), or a compound of cyclic structure having the general formula (7-2).

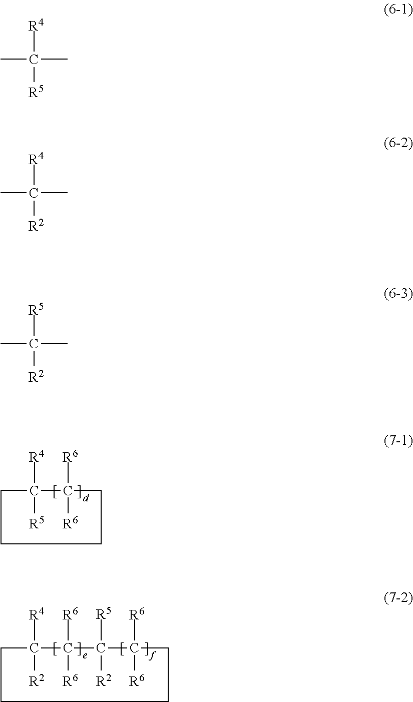

Herein R² is a substituted or unsubstituted monovalent hydrocarbon group of 1 to 10 carbon atoms, R⁴ is a substituent group of 2 to 10 carbon atoms containing alkynyl, acryloyloxy or methacryloyloxy, R⁵ is a substituent group having an OH, SiH or alkenyl group as functionality, R⁶ is hydrogen, a saturated hydrocarbon group of 1 to 10 carbon atoms or aromatic group, the same group as R⁴, or the same group as R⁵, d is 4 to 10, and e+f is 3 to 9.

In a preferred embodiment, the release silicone composition is of addition and condensation reaction cure type.

The primer silicone composition may further comprise some or all of components of the release silicone composition.

In another aspect, the invention provides a treated paper or film substrate obtained by coating a surface of a paper or film substrate with the primer silicone composition defined above and exposing to UV radiation, wherein the treated surface will be overlaid with a cured coating of a release silicone composition to form a release paper or film.

In a further aspect, the invention provides a release paper or film comprising the treated paper or film substrate and a release silicone composition coated and cured to the treated substrate surface.

### ADVANTAGEOUS EFFECT OF INVENTION

According to the invention, a primer silicone composition comprising an adhesion-providing component of specific structure is coated onto a paper or plastic film substrate and exposed to UV radiation to form a primer layer, before a conventional release silicone composition is coated and cured onto the substrate. The primer layer improves the adhesion between the release silicone coating and the substrate. As opposed to the prior art techniques of improving adhesion at more or less sacrifice of release properties, the invention can improve adhesion without substantial impact on release properties.

### DESCRIPTION OF EMBODIMENTS

### Primer Silicone Composition

The primer silicone composition of the invention comprises (A) an adhesion-providing component which is component (A-1) and/or (A-2) as defined below and optionally, (B) an organic solvent. The primer silicone composition is coated onto a paper or plastic film substrate and exposed to UV radiation to form a primer layer. Thereafter, a conventional release silicone composition is coated and cured onto the substrate, yielding a release paper or film having improved adhesion.

Component (A) is a characteristic component for the primer silicone composition to enhance adhesion as the primer. It functions like a coupling agent capable of coupling the substrate and a non-tacky cured coating of a release silicone composition, thereby improving adhesion. If only one type of reaction is utilized for reaction or interaction with the substrate and the non-tacky cured coating made of essentially different materials, the reaction tends to be biased to either one side whereby the relevant component may not fully function as the coupling agent. Thus, according to the invention, radical reaction is assigned to the reaction or interaction with the substrate whereas addition or condensation reaction is assigned to the reaction or interaction with the non-tacky cured coating.

Component (A) must serve such that a single molecule may accommodate these two different reactions. One approach to this goal is to provide one molecule solely with substituent groups of the same type containing only a functional group capable of both the reactions. Although the reaction selectivity by the substituent group is low, two reactions proceed, without biasing, depending on the characteristics of the molecular structure. The organosiloxane corresponding to this approach is component (A1).

Another approach is to provide one molecule with both a substituent group capable of radical reaction with the substrate rather than addition or condensation reaction, and another substituent group capable of addition or condensation reaction with the non-tacky cured coating of release silicone composition rather than radical reaction. The compound corresponding to this approach is component (A2).

Component (A) may be component (A1) or (A2) or a mixture of components (A1) and (A2). Components (A1) and (A2) may be mixed preferably in a weight ratio (A1):(A2) from 100:0 to 100:100, more preferably from 100:0 to 100:90, although the mixing ratio may be suitably adjusted in accordance with the desired level of adhesion, the type of substrate, and curing conditions. When a mixture of components (A1) and (A2) is used, the weight ratio (A1):(A2) preferably ranges from 100:5 to 100:100.

Since component (A1) does not require that a plurality of different functional groups be incorporated within one molecule as in component (A2), it is easy to prepare and advantageous in availability and cost. In addition, since component (A1) is a silicone compound similar to the main component of the release silicone composition to be overcoated, it is advantageous for reaction or interaction with the non-tacky cured coating. Although this feature is detrimental to reaction or interaction with the surface of a substrate of organic material, it is compensated for by the following. This component is previously coated on the substrate as the primer and exposed to UV radiation whereby radical reaction takes place earlier. The vicinal juxtaposition of alkenyl groups as shown in formula (1) ensures that alkenyl groups are concentrated within a short siloxane chain to increase the organic nature of the functional portion. The resulting structure is advantageous for radical reaction with the substrate.

Component (A1) is an organopolysiloxane having a structure that two siloxane units in which an alkenyl-containing substituent group is bonded to silicon atom are linked directly or via up to 3 intervening siloxane units in which the alkenyl-containing substituent group is not bonded to silicon atom.

Specifically, the organopolysiloxane as component (A1) may be represented by the compositional formula (1) having a structure of the general formula (2).

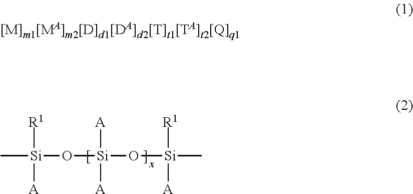

Herein R¹ is an alkenyl-containing substituent group of 2 to 10 carbon atoms, A is R² or a siloxane residue bonded via an oxygen atom and selected so as to meet formula (1), two A groups connected to one silicon atom may form a cyclic structure as —O(SiR²₂O)_{y}—, R² is a substituted or unsubstituted monovalent hydrocarbon group of 1 to 10 carbon atoms, x is an integer of 0 to 3, y is an integer selected such that the organopolysiloxane of formula (1) may have an average degree of polymerization of 2 to 50.

M, M^{A}, D, D^{A}, T, T^{A}, and Q are siloxane units as defined below, O_{1/2} denoting that adjacent siloxane units are linked via an oxygen atom.

M and M^{A} each are:

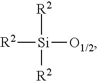

with the proviso that at least one R² in M^{A} is R¹.
D and D^{A} each are:

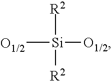

with the proviso that at least one R² in D^{A} is R¹.
T and T^{A} each are:

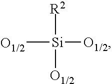

with the proviso that R² in T^{A} is R¹.

### Q is:

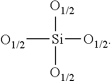

The subscripts m1, m2, d1, d2, t1, t2, and q1 are numbers satisfying the equations:

t1+t2+2×q1≦m1+m2≦2+t1+t2+2×q1

0≦d1+d2≦48, 0≦t1+t2≦30, 0≦q1≦20,

0.25≦(m2+d2+t2)/(m1+m2+d1+d2+≦t1+t2+q1)≦1.

Examples of the alkenyl-containing substituent group represented by R¹ include alkenyl groups such as vinyl and allyl, and (meth)acryloyloxy-substituted alkyl groups such as acryloyloxypropyl and methacryloyloxypropyl.

Suitable monovalent organic groups represented by R² include unsubstituted monovalent hydrocarbon groups, for example, straight, branched or cyclic alkyl groups such as methyl, ethyl, propyl and hexyl, aryl groups such as phenyl and tolyl, aralkyl groups such as benzyl, and alkenyl groups such as vinyl and allyl, and substituted forms of the foregoing monovalent hydrocarbon groups in which some or all hydrogen atoms are substituted by halogen atoms, and substituted forms of the alkyl groups in which a hydrogen atom is substituted by (meth)acryloyloxy, such as (meth)acryloyloxypropyl. Accordingly, R² may be R¹.

A is R² or a siloxane residue bonded via an oxygen atom and selected so as to meet formula (1), for example, methyl, ethyl, propyl, vinyl, allyl, (meth)acryloxypropyl, —O—Si(CH₃)₂(CH)═(CH₂), —O—Si(CH₃)₃, —O—Si(CH₁)₂(C₆H₅), methoxy, ethoxy, and propoxy groups. Two A groups connected to one silicon atom may form a cyclic structure as —O(SiR²₂O)_{y}— wherein R² and y are as defined above. More specifically,

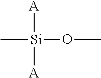

may be a group of

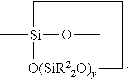

Component (A1) has an average degree of polymerization of 2 to 50, preferably 2 to 40, as measured by gel permeation chromatography (GPC) versus polystyrene standards. The subscript y is an integer selected such that the organopolysiloxane of formula (1) may have an average degree of polymerization within the range. Specifically, y is preferably an integer of 0 to 10, more preferably 1 to 8.

As seen from formula (2), the organosiloxane as component (A1) has a structure that two —SiR¹A- groups are linked via —O—(SiA₂O)ₓ— wherein x is 0 to 3, preferably O or 1. Namely, two —SiR¹A- groups having a silicon-bonded alkenyl group are juxtaposed in vicinity. When A is alkenyl, such groups are juxtaposed in close vicinity as a matter of course. Even when A is an alkyl group such as methyl or an aryl group such as phenyl, two —SiR¹A- groups are juxtaposed in vicinity. The subscript x representative of an extent of vicinity is at most 3, preferably 0 or 1, within which range the effect of the invention are achievable. If x is 4 or more, adhesion declines, failing to achieve the effect of improving adhesion without an impact on release performance.

Another effect expectable from the vicinal juxtaposition of alkenyl groups is that radical reaction proceeds predominantly while addition reaction is retarded. This effect becomes more significant when x is 0 or 1. The reason why the vicinal juxtaposition of alkenyl groups retards addition reaction is analogized from the fact that a compound of the identical structure can be utilized as an inhibitor. Once one alkenyl group is altered by radical reaction, the remaining alkenyl group becomes available for addition reaction, whereby reaction with the non-tacky cured coating takes place. In this way, the organosiloxane fully functions as the coupling agent.

If possible, the organosiloxane preferably contains at least three alkenyl groups, more preferably at least four alkenyl groups per molecule so that all alkenyl groups may not be consumed solely by the radical reaction. A low molecular weight is advantageous for the organosiloxane to function as the coupling agent because more bond sites are available over a wide area.

Examples of the organosiloxane having the structure of formula (1) include linear or branched organopolysiloxanes having the following formula (3) or (4).

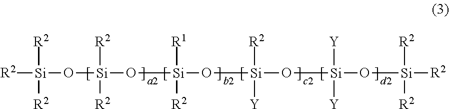

Herein R¹ and R² are as defined above, Y is a group of the following formula (3a):

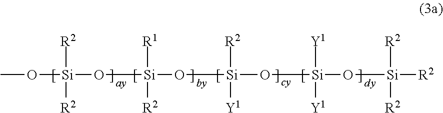

wherein R¹ and R² are as defined above. Y¹ is a group of the following formula (3b):

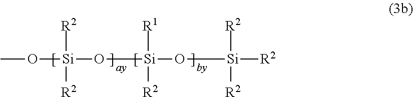

wherein R¹ and R² are as defined above.

The subscripts a2, b2, ay, and by each are an integer of 0 to 48, preferably 0 to 45, more preferably 0 to 40, c2 and cy each are an integer of 0 to 30, preferably 0 to 25, more preferably 0 to 20, d2 and dy each are an integer of 0 to 20, preferably 0 to 18, more preferably 0 to 15.

Formulae (3), (3a) and (3b) each denote a random structure and include at least one structure that two siloxane units in which the alkenyl-containing substituent group R¹ is bonded to silicon atom are linked directly or via up to 3 intervening siloxane units in which R¹ is not bonded to silicon atom.

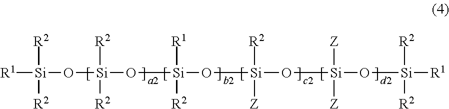

wherein R¹ and R² are as defined above, Z is a group of the following formula (4a):

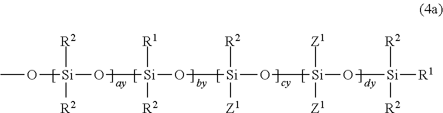

wherein R¹ and R² are as defined above. Z¹ is a group of the following formula (4b):

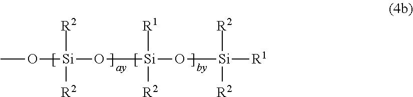

wherein R¹ and R² are as defined above.

The subscripts a2, b2, ay, and by each are an integer of 0 to 48, preferably 0 to 45, more preferably 0 to 40, c2 and cy each are an integer of 0 to 30, preferably 0 to 25, more preferably 0 to 20, d2 and dy each are an integer of 0 to 20, preferably 0 to 18, more preferably 0 to 15.

Formulae (4), (4a) and (4b) each denote a random structure and include at least one structure that two siloxane units in which the alkenyl-containing substituent group R¹ is bonded to silicon atom are linked directly or via up to 3 intervening siloxane units in which R¹ is not bonded to silicon atom.

Illustrative structures as component (A1) include linear organopolysiloxanes having the following formula:

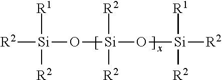

wherein x is as defined above. Also included are organopolysiloxanes of branched structure having a backbone of tri- or tetra-functional siloxane units, of the following formulae.

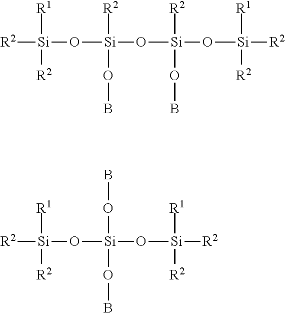

Examples of the siloxane residue A, Y, Z, and B are given below.

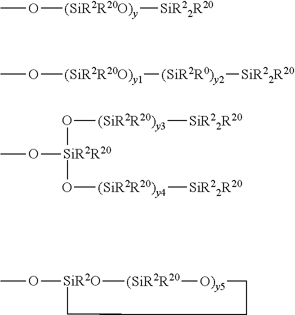

Herein R²⁰ is R² or R¹, R⁰ is —O—(SiR²R²⁰)_{y6}SiR²₂R²⁰, y is as defined above, y1+y2+y6=y, y1 and y6 each are an integer of at least 0, y2 is an integer of at least 1, y3+y4=y, y3 and y4 each are an integer of at least 0, and y5=y.

More specific examples are given below.

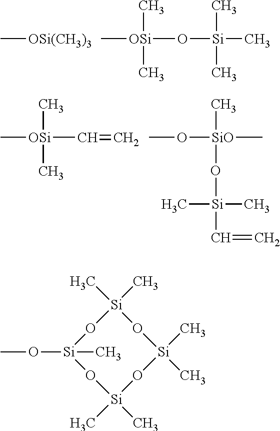

Component (A1) may also be an organopolysiloxane of cyclic structure having the general formula (5), which minimizes the influence of siloxane structure and is more advantageous for radical reaction.

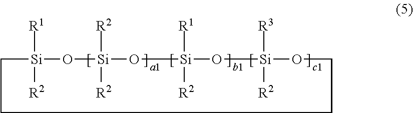

Herein R¹ and R² are as defined above, R³ is a substituent group having an OH or SiH group as functionality or a substituted or unsubstituted monovalent hydrocarbon group of 1 to 10 carbon atoms free of aliphatic unsaturation, a1 is 0 or 1, b1 is an integer of 1 to 6, c1 is an integer of 0 to 5, and a1+b1+c1 is an integer of at least 2.

In formula (5), examples of the substituent group having an OH or SiH group as functionality, represented by R³, include silicon-bonded hydroxyl, silicon-bonded hydrogen, —CH₂CH₂CH₂—O—CH₂CH₂—OH, and the like. Examples of the monovalent hydrocarbon group represented by R³ include those exemplified above for R², with alkenyl groups being excluded.

Industrially desirable as component (A1) are those siloxanes of formula (5) wherein R¹ is vinyl, R² is methyl, R³ is hydrogen, a1 is 0 to 1, b1 is 1 to 4, and c1 is 0 to 1, and more desirably a1=0, b1=2 to 4, and c1=0.

It is noted that component (A1) is an organosiloxane having a high alkenyl content, preferably of 0.3 to 2.0 mol/100 g, more preferably 0.4 to 1.5 mol/100 g. When the organosiloxane has a low molecular weight corresponding to a low degree of polymerization so that it may have an absolute viscosity of less than 0.04 Pa-s at 25° C. as measured by a rotational viscometer, it is more susceptible to reaction or interaction with the substrate. If possible, the organosiloxane preferably contains at least three alkenyl groups, more preferably at least four alkenyl groups per molecule so that all alkenyl groups may not be consumed solely by the radical reaction. It is noted that the lower limit of the absolute viscosity is usually 0.1 mPa-s, though not critical.

Component (A2) is a compound containing in a molecule at least one substituent group of 2 to 10 carbon atoms, preferably 2 to 8 carbon atoms, having a carbon-carbon unsaturated bond (double or triple bond) as functionality, and at least one substituent group having a group capable of addition reaction and/or condensation reaction with an alkenyl group and/or a silicon-bonded hydrogen atom (i.e., SiH group).

The compound as component (A2) possesses at least one substituent group having a carbon-carbon unsaturated bond as functionality, which indicates a substituent group having a functional group capable of radical reaction upon exposure to heat and/or UV. The structure of this substituent group may be either linear or branched, or even a cyclic structure such as cyclohexene or norbornadiene may be used. Any substituent group having a functional group as commonly used in radical polymerization or radical reaction curing systems may be used. Where component (A2) contains a siloxane structure, the substituent group should preferably be a substituent group having a carbon-carbon double bond such as methacryloyloxy or a carbon-carbon triple bond such as acetylene, propynyl or butynyl, especially for restraining consumption by addition reaction.

In a relative sense, the structure of component (A1) is susceptible to reaction and interaction with an overlying release silicone composition whereas the structure of component (A2) is advantageous for reaction and interaction with a substrate composed mainly of organic material. Although the desired effect is obtainable with component (A1) or (A2) alone, better effects are achievable over a wider variety of substrates using a mixture of components (A1) and (A2). When such a mixture is used, component (A2) of siloxane structure should desirably have a lower molecular weight and a lower degree of polymerization which is specifically up to 40, more specifically 1 to 10.

Where component (A2) is an organic compound free of siloxane structure, it makes an easy access to the substrate and is advantageous for reaction or interaction with the substrate via radical reaction, allowing a choice of the substituent group from a wider range. However, a non-silicone compound having a higher molecular weight has an inferior wettability with the overlying silicone thereby resulting in an inferior adhesion. Therefore, the organic compound should preferably have a number average molecular weight of up to 1,000 as measured by GPC versus polystyrene standards. In order for the organic compound to function as a coupling agent more efficiently for improving adhesion, a lower molecular weight is desirable since more bond sites are available over a wide area.

In component (A2), the substituent group having a functional group capable of radical reaction upon exposure to heat and/or UV functions such that component (A2) is anchored to the substrate surface where the composition is coated, through radical reaction and/or interaction with a group created by radical reaction. Creation of radicals may be attained by heat or irradiation of energy ray such as UV. Alternatively a radical generator such as peroxide or a photosensitizer may be added for the purpose of promoting radical creation insofar as the advantages of the invention are not impaired.

Since the substrate is made of organic material, there are present on the substrate numerous structures capable of generating radicals upon exposure to heat or UV or numerous structures capable of reacting with radicals thus generated. In addition, the substrate has an extremely high rate of absorption of IR or UV radiation as the radical-generating energy source. Thus radicals can be concentratedly generated on the substrate, which is apt to promote reaction with the substrate.

In the case of heat-sensitive substrates such as plastic film, the radical creation technique based on UV irradiation is advantageous in that the temperature of the film substrate is not so elevated. Using UV radiation, the majority of which is absorbed by the film substrate surface, radicals can be concentratedly generated in proximity to the film substrate surface, which is desirable to promote reaction with the film substrate.

The compound as component (A2) also possesses at least one second substituent group. It is a substituent group having a functional group capable of reaction with an alkenyl group and/or SiH group. It is assumed that the alkenyl group is the functional group that the main component of the overcoating release silicone composition has and the SiH group is a functional group that the crosslinker has, provided that the overcoating release silicone composition is of addition reaction cure type. Suitable substituent groups include those having a SiH group capable of addition reaction with the alkenyl group, and those having an OH group capable of condensation reaction or a carbon-carbon double bond capable of addition reaction with the SiH group.

The second substituent group in component (A2) functions such that component (A2) is anchored to the non-tacky cured coating through addition and condensation reactions different from the radical reaction of the first substituent group. With this combined with the action of the substituent group for radical reaction, component (A2) functions as a coupling agent of anchoring the non-tacky cured coating and the substrate to each other, thereby improving adhesion.

Where component (A2) is an organic compound free of siloxane structure, it rather favors radical reaction with the substrate. If a substituent group having a carbon-carbon double bond as a functional group capable of reaction with an alkenyl group and/or SiH group is selected, then it is mostly consumed by radical reaction. As a result, fewer substituent groups are available for addition reaction with the SiH group, with the risk of component (A2) failing to function as the coupling agent. To avoid such inconvenience, a SiH group or hydroxyl group unsusceptible to radical reaction is selected. For example, the compound may be a molecular structure containing a divalent structure having the general formula (6-1), or two divalent structures having the general formulae (6-2) and (6-3).

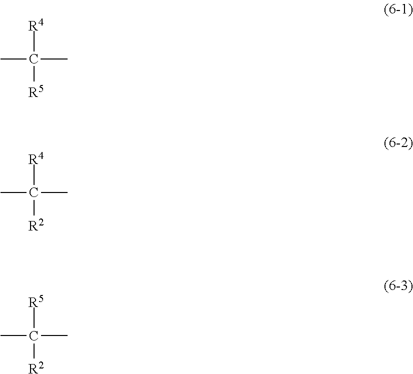

Herein R² is as defined above, R⁴ is a substituent group of 2 to 10 carbon atoms, preferably 2 to 8 carbon atoms, containing alkynyl (e.g., acetylene, propynyl or butynyl), acryloyloxy or methacryloyloxy, and R⁵ is a substituent group having an OH, SiH or alkenyl group as functionality. Of these structures, an industrially desirable example is HC≡C—C(CH₃)₂—OH.

Also included are cyclic structures having the general formulae (7-1) and (7-2).

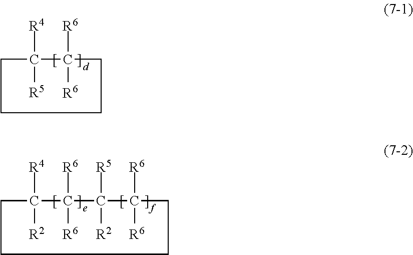

Herein R⁴ and R⁵ as defined above, R⁶ is hydrogen, a saturated hydrocarbon group of 1 to 10 carbon atoms, preferably 1 to 8 carbon atoms, or aromatic group, the same group as R⁴, or the same group as R⁵, d is 4 to 10, and e+f is 3 to 9. Of these structures, an industrially desirable example is ethynyl cyclohexanol.

Both components (A1) and (A2) are commonly advantageous in that their molecular weight is low. However, a compound having a very low molecular weight has a risk that it will rapidly volatilize off from the substrate prior to any reaction when the primer composition is coated and heated on the substrate. It is thus desired that component (A) have such a molecular weight that its boiling point may be at least 80° C. For mitigating thermal impact, UV irradiation is effective because the temperature is not elevated.

Component (B) is an organic solvent which is optionally added to the primer silicone composition for the purposes of improving the applicability to various substrates and adjusting the coating weight and viscosity of the composition. Suitable organic solvents include toluene, xylene, ethyl acetate, acetone, methyl ethyl ketone, and hexane. Any other organic solvents may be used as long as component (A) can be uniformly dissolved therein. When blended, the organic solvent is used in an amount of 1 to 99,900 parts, preferably 100 to 10,000 parts by weight per 100 parts by weight of component (A). Note that component (B) is optional. Absent component (B), the viscosity of components is changed to adjust an overall viscosity such that the resulting composition may be effectively coated by an applicator.

The primer silicone composition may be prepared simply by mixing components (A) and (B) until uniform.

If desired, additives including a photosensitizer, radical generator, leveling agent, and wetter may be added to the primer silicone composition insofar as the advantages of the invention are not impaired. Also some or all of the components of the release silicone composition to be described later may be added to the primer silicone composition insofar as the advantages of the invention are not impaired.

The primer silicone composition is coated onto a substrate such as paper or plastic film directly or after diluting with a suitable organic solvent, by any well-known coating techniques, for example, using a bar coater, roll coater, reverse coater, gravure coater, air knife coater, or if thin-film coating is desired, a high-precision offset coater or multi-stage roll coater. Examples of the substrate include paper sheets such as glassine paper, polyethylene-laminated paper, kraft paper, clay-coated paper, and mirror-coated paper, and plastic films of polypropylene, polyethylene, polyethylene terephthalate (PET), polyvinyl chloride and the like.

The coating weight of the primer silicone composition on the substrate varies with the type of the substrate material. The preferred coating weight is in a range of 0.0005 to 0.1 g/m² as solids. The substrate coated with the primer silicone composition is then exposed to UV radiation. When the solvent is used, the solvent may be evaporated off by air drying or heating. Drying and UV irradiation may be done simultaneously or separately and in any order as long as the benefits of the invention are obtainable.

For UV irradiation, any commercially available lamps or bulbs such as mercury lamps, metal halide lamps and fusion lamps may be used. Since the film substrate has a high absorption coefficient at 300 nm or shorter, those lamps or bulbs having a wavelength distribution containing more fractions of 300 nm or shorter wavelength are effective. An integral dose is 10 to 500 mJ/cm², which is obtained by irradiation, for example, from one or two 120-W lamps at a line speed of 10 to 100 m/min. Drying is typically effected at 20 to 120° C. for 5 to 60 seconds.

After the primer silicone composition is coated on a paper or film substrate and exposed to UV radiation, there is obtained a treated paper or film substrate. On the primed or treated surface of the substrate, a release silicone composition is coated and cured, yielding a release paper or film.

### Release Silicone Composition

The overlying release silicone composition used herein may be of addition and condensation type, and any commercially available compositions may be used. The form of the composition is not particularly limited and it may take solvent, solventless or emulsion form. A silicone composition of addition cure type comprising (C) an alkenyl-containing organopolysiloxane, (D) an organohydrogenpolysiloxane, (E) an addition reaction catalyst, and optionally (F) an organic solvent is typical although the composition is not limited thereto.

### Component C

Component (C) is an organopolysiloxane containing at least two alkenyl groups in a molecule. Specifically, the organopolysiloxane is of a structure having the general formula (8).

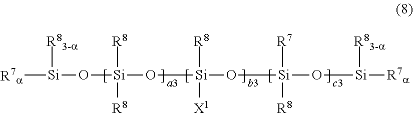

Herein R⁷ is alkenyl, R⁸ is a monovalent organic group free of aliphatic unsaturation or a hydroxyl group, X¹ is a group of formula (9):

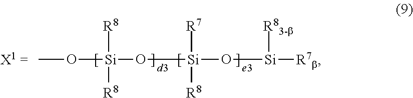

a3, b3, c3, d3, and e3 are such positive numbers that the organopolysiloxane may have a viscosity of at least 0.04 Pa-s at 25° C. and a viscosity in 30 wt % toluene solution of up to 70 Pa-s at 25° C., as measured by a rotational viscometer, b3, c3, d3, and e3 may be 0, α and β each are 0 or an integer of 1 to 3.

Specifically, R⁷ is an alkenyl group, preferably of 2 to 6 carbon atoms, such as vinyl, allyl or butenyl. R⁸ is selected from monovalent organic groups, typically monovalent hydrocarbon groups, preferably of 1 to 20 carbon atoms, more preferably of 1 to 8 carbon atoms, for example, C₁-C₁₂ alkyl groups such as methyl, ethyl, propyl and butyl, C₄-C₂₀ cycloalkyl groups such as cyclohexyl, C₆-C₂₀ aryl groups such as phenyl and tolyl, and substituted forms of the foregoing in which some or all hydrogen atoms are replaced by halogen, cyano or the like, such as chloromethyl, trifluoropropyl, and cyanoethyl, as well as monovalent hydrocarbon groups containing C₁-C₁₂ alkoxy groups (e.g., methoxy, ethoxy, propoxy and methoxyethoxy), hydroxyl, or C₂-C₂₀ epoxy groups, such as glycidyl, glycidyloxy, or epoxycyclohexyl-substituted alkyl groups. R⁸ is free of aliphatic unsaturation. From the industrial standpoint, R⁷ is preferably vinyl. It is preferred for preparation and properties that methyl account for at least 80 mol % of R⁸ in the overall organopolysiloxane as component (C).

While the organopolysiloxane as component (C) should contain at least two alkenyl groups per molecule, the content of alkenyl is desirably 0.001 to 0.3 mole per 100 g of the organopolysiloxane. In formula (8) and substituent group X¹, a3, b3, c3, d3, and e3 are selected such that the number of alkenyl groups per molecule: c3+b3×(e3+β)+2α may fall in the range of 2 to 2,500.

Although the main skeleton structure of the organopolysiloxane (C) is linear, an organopolysiloxane containing a branched chain structure as shown by the formula wherein b3 is not equal to 0 may also be employed.

### Component D

Component (D) is an organohydrogenpolysiloxane containing at least three silicon-bonded hydrogen atoms (i.e., SiH groups) in a molecule. Preferably it has the average compositional formula (10):

R⁸_{f}H_{g}SiO_{(4-f-g)/2} (10)

wherein R⁸ is as defined above, f is 0 to 3, g is 0 to 3, and f+g is a positive number of 1 to 3.

The molecular structure may be linear, branched or cyclic. The organohydrogenpolysiloxane has an absolute viscosity which may range from several mPa-s to several ten thousand mPa-s at 25° C. as measured by a rotational viscometer. Illustrative examples of the organohydrogenpolysiloxane are given below.

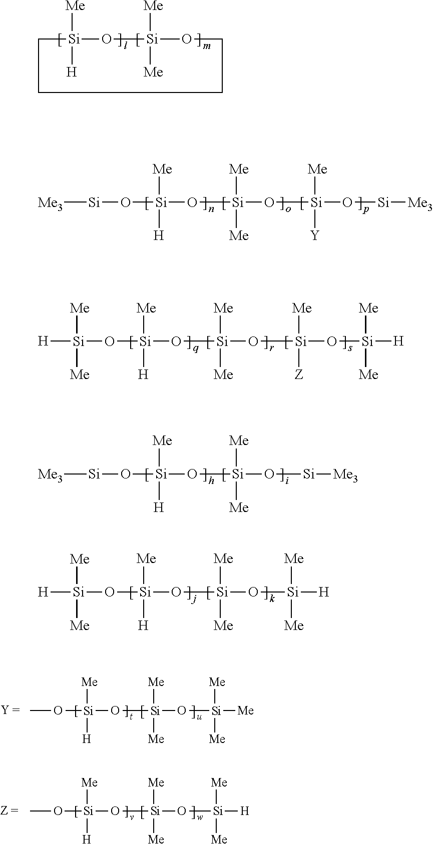

Herein, Me stands for methyl, h, 1 and n each are a number of 3 to 500, m, p and s each are a number of 1 to 500, i, j, k, o, q, r, t, u, v and w each are a number of 0 to 500.

The organohydrogenpolysiloxane as component (D) is blended in such amounts that the moles of SiH group is 1 to 10 times, preferably 1 to 5 times the total moles of alkenyl group in component (C). Generally speaking, an appropriate amount of component (D) blended is 0.1 to 10 parts by weight per 100 parts by weight of component (C).

### Component E

Component (E) is a platinum group metal base catalyst which may be selected from prior art well-known catalysts for addition reaction. Exemplary catalysts include platinum black, chloroplatinic acid, chloroplatinic acid-olefin complexes, chloroplatinic acid-alcohol coordination compounds, rhodium, and rhodium-olefin complexes. The catalyst may be added in a catalytic amount, preferably in such an amount as to provide 5 to 1,000 ppm of platinum or rhodium based on the total weight of components (C) and (D), whereby a coating can be fully cured. The amount of the catalyst may be adjusted in accordance with the reactivity of the components or the desired cure rate.

### Component F

Component (F) is an organic solvent which is added to the release silicone composition for the purposes of improving the stability of processing bath and applicability to various substrates and adjusting the coating weight and viscosity of the composition. The solvent may be the same an component (B) in the primer silicone composition. Suitable organic solvents include toluene, xylene, ethyl acetate, acetone, methyl ethyl ketone, and hexane. Any other organic solvents may be used as long as the components can be uniformly dissolved therein. When blended, the organic solvent is used in an amount of 100 to 9,900 parts by weight per 100 parts by weight of component (C). Note that component (F) is optional. Absent component (F), the viscosity of other components is changed to adjust an overall viscosity such that the resulting composition may be effectively coated by an applicator. The stability of processing bath may be adjusted by adding a bath life extender or the like, if necessary.

The release silicone composition may be prepared simply by mixing components (C), (D), (E), and (F) until uniform. To gain an appropriate pot life, component (E) should be added and mixed immediately before coating. When component (F) or organic solvent is used, one advantageous procedure is by dissolving components (C) and (D) in component (F) uniformly prior to mixing component (E) therewith.

If desired, additives including a pigment, leveling agent, and bath life extender may be added to the release to silicone composition.

The release silicone composition is coated onto the treated paper or film substrate directly or after diluting with a suitable organic solvent, by any well-known coating techniques, for example, using a bar coater, roll coater, reverse coater, gravure coater, air knife coater, or if thin-film coating is desired, a high-precision offset coater or multi-stage roll coater.

The coating weight of the release silicone composition on the primed substrate varies with the intended application. The preferred coating weight is in a range of 0.05 to 5 g/m² as solids. The substrate coated with the release silicone composition is heated at 80 to 150° C. for 5 to 60 seconds to form a cured coating on the primed substrate surface, obtaining a release paper or film.

As described above, some or all of the components of the release silicone composition may be added to the primer silicone composition for the purposes of improving the substrate wettability and applicability of the primer composition, and the primer layer's ability to receive the overlying release silicone composition. Namely one or more of components (C), (D) and (E) may be incorporated into the primer silicone composition. When these components are incorporated into the primer silicone composition, component (C) is preferably used in an amount of 1 to 100 parts by weight per 100 parts by weight of component (A). Component (D) is preferably used in an amount of 1 to 10 moles, more preferably 1 to 5 moles per mole of alkenyl groups in components (A) and (C) combined. Too much component (D) is undesirable because the pot life may become short, detracting from working efficiency. Component (E) is preferably used in such an amount as to provide 1 to 1,000 ppm, more preferably to 800 ppm of platinum or rhodium based on the total weight of components (A), (C), and (D). Too much component (E) is undesirable because the pot life may become short, detracting from working efficiency.

In the embodiment wherein one or more of components (C), (D) and (E) are incorporated into the primer silicone composition, the coating technique, coating weight and curing conditions may be the same as above. The primer coating may be heated at 100 to 120° C. for 5 to 30 seconds, if necessary, for rendering the coating non-tacky.

### EXAMPLE

Examples of the invention are given below by way of illustration and not by way of limitation. All parts are by weight. Me stands for methyl, and Vi for vinyl. The viscosity is an absolute viscosity measured at 25° C. by a rotational viscometer.

### Examples 1 to 17 and Comparative Examples 1 to 8

A primer silicone composition was prepared by mixing the amounts indicated in Table 1 of components (A) and (Q). The composition was coated onto a PET or OPP substrate in a coating weight of 0.005 g/m², exposed to UV radiation from two 80-W UV lamps at a line speed of 40 m/min in an integral dose of 50 mJ/cm², and heat treated in a hot air circulating dryer at 80° C. for 10 seconds, yielding a primed substrate.

An overcoat composition or release silicone composition was prepared by mixing the amounts indicated in Table 1 of components (C), (D) and (F) and an amount of component (E) so as to provide 100 ppm of platinum based on the total weight of (C)+(D). The release silicone composition was coated onto the primed substrate in a coating weight of 0.5 g/m² and heat cured at 100° C. for 30 seconds, yielding a release film which was evaluated according to the evaluation method described later.

### Comparative Example 9

A primer silicone composition was prepared by mixing the amounts indicated in Table 1 of components (A) and (B), coated onto a substrate, and heat treated in a hot air circulating dryer at 80° C. for 30 seconds. UV irradiation was omitted. In this way, a primed substrate was obtained. Thereafter, a release film was manufactured and evaluated as above.

The components in Table 1 are identified below.

Component A

(A1-1) siloxane, viscosity 5 mPa-s, Vi content 1.2 mol/100 g

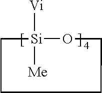

(A1-2) siloxane, viscosity 5 mPa-s, Vi content 0.63 mol/100 g

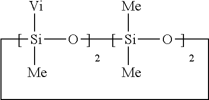

(A1-3) siloxane, viscosity 10 mPa-s, Vi content 0.6 mol/100 g

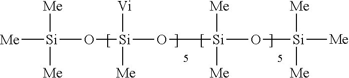

(A1-4) siloxane, viscosity 6 mPa-s, Vi content 0.7 mol/100 g

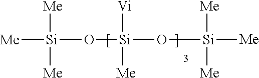

(A1-5) siloxane, viscosity 0.02 Pa-s, alkenyl content 0.33 mol/100 g

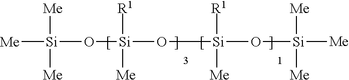

R¹ is —CH₂CH₂CH₂—O—CO—(CH₃)C═CH₂ (127).

R² is —CH₂CH₂CH₂—O—CH₂CH₂—OH (106).

(A1-6) siloxane, viscosity 6 mPa-s, alkenyl content 0.49 mol/100 g

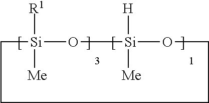

R¹ is —CH₂CH₂CH₂—O—CO—(CH₃)C═CH₂ (127).

(A1-7) siloxane, viscosity 5 mPa-s, Vi content 0.32 mol/100 g

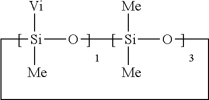

(A1-8) siloxane, viscosity 6 mPa-s, Vi content 0.32 mol/100 g

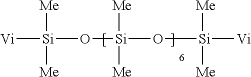

(A1-9) siloxane, viscosity 0.035 Pa-s, Vi content 0.32 mol/100 g

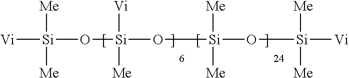

(A1-10) siloxane, viscosity 0.03 Pa-s, alkenyl content 0.75 mol/100 g

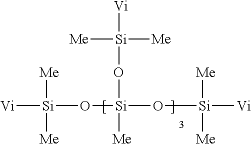

(A1-11) siloxane, viscosity 0.02 Pa-s, alkenyl content 0.93 mol/100 g

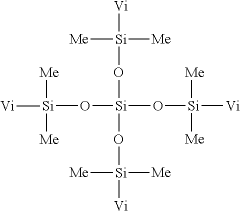

(A1-12) siloxane, viscosity 0.04 Pa-s, alkenyl content 0.88 mol/100 g

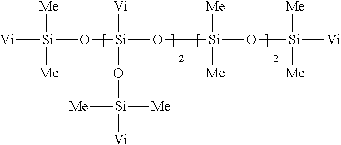

(A2-1) acetylene alcohol, 3-methyl-1-butyn-3-ol
(A2-2) acetylene alcohol, 3,5-dimethyl-1-hexyn-3-ol
(A2-3) acetylene alcohol, 1-ethynyl-1-cyclohexanol
(A2-4) acetylene compound, 1-octyne

Component B

(B-1) solvent, 50/50 (weight ratio) toluene/heptane mixture—

Component C

(C-1) organopolysiloxane, viscosity at 25° C. in 30 wt % toluene solution 10 Pa-s, Vi content 0.032 mol/100 g

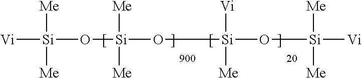

(C-2) organopolysiloxane, viscosity 2 Pa-s, Vi content 0.026 mol/100 g

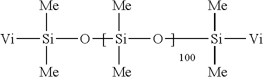

(C-3) organopolysiloxane, viscosity at 25° C. in 30 wt % toluene solution 5 Pa-s, Vi content 0.035 mol/100 g

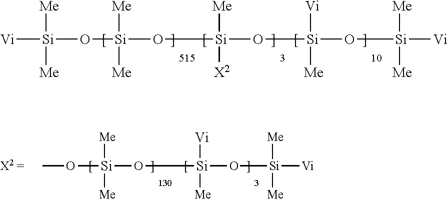

(C-4) organopolysiloxane, viscosity 1 Pa-s, Vi content 0.043 mol/100 g

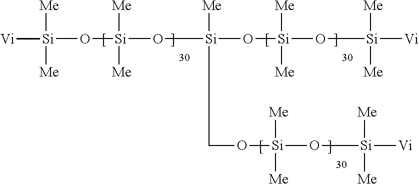

Component D

(D-1) methylhydrogenpolysiloxane, viscosity 25 mPa-s, H content 1.5 mol/100 g

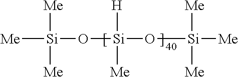

(D-2) methylhydrogenpolysiloxane, viscosity 60 mPa-s, H content 1.00 mol/100 g

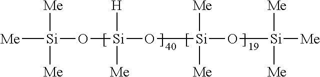

Component E

(E-1) catalyst, platinum-vinylsiloxane complex

Component F

The same as component B

TABLE 1

| | | | | | | | | Peeling | | |
|---|---|---|---|---|---|---|---|---|---|---|
| | | Component (pbw) | | | | | | force | Adhesion | |
| No. | | A1 | A2 | B | C | D | F | (N) | PET | OPP |
| Example | 1 | A1-1 | | 99.9 | C-1 | D-1 | 90 | 0.4 | ⊚ | ⊚ |
| | | 0.1 | | | 100 | 2 | | | | |
| | 2 | A1-2 | | 99.8 | C-1 | D-1 | 2,090 | 0.6 | ◯ | ◯ |
| | | 0.2 | | | 100 | 2 | | | | |
| | 3 | A1-3 | | 99.8 | C-1 | D-1 | 2,090 | 0.5 | ◯ | ◯ |
| | | 0.2 | | | 100 | 2 | | | | |
| | 4 | A1-4 | | 99.8 | C-3 | D-2 | 2,147 | 0.65 | ◯ | ◯ |
| | | 0.2 | | | 100 | 4 | | | | |
| | 5 | A1-5 | | 99.8 | C-3 | D-2 | 2,128 | 0.7 | ◯ | ◯ |
| | | 0.2 | | | 100 | 4 | | | | |
| | 6 | A1-6 | | 99.9 | C-3 | D-2 | 2,071 | 0.55 | ⊚ | ⊚ |
| | | 0.1 | | | 100 | 4 | | | | |
| | 7 | | A2-1 | 99.95 | C-1 | D-1 | 1,995 | 0.35 | ◯ | ◯ |
| | | | 0.05 | | 100 | 2 | | | | |
| | 8 | | A2-2 | 99.975 | C-3 | D-1 | 1,986 | 0.5 | ◯ | ◯ |
| | | | 0.025 | | 100 | 4 | | | | |
| | 9 | A1-1 | | 99.9 | C-2 | D-1 | — | 0.5 | ⊚ | ⊚ |
| | | 0.1 | | | 100 | 4 | | | | |
| | 10 | A1-2 | | — | C-4 | D-2 | — | 0.7 | ◯ | ◯ |
| | | 100 | | | 100 | 10 | | | | |
| | 11 | A1-1 | | — | C-2 | D-1 | — | 0.5 | ◯ | ◯ |
| | | 100 | | | 100 | 4 | | | | |
| | 12 | A1-1 | A2-3 | 99.885 | C-4 | D-2 | — | 0.6 | ⊚ | ⊚ |
| | | 0.1 | 0.015 | | 100 | 10 | | | | |
| | 13 | A1-1 | | 99.9 | C-1 | D-1 | 2,014 | 0.4 | ◯ | ◯ |
| | | 0.1 | | | 100 | 4 | | | | |
| | 14 | A1-1 | | 99.9 | C-1 | D-1 | 2,014 | 0.4 | ◯ | ◯ |
| | | 0.1 | | | 100 | 4 | | | | |
| | 15 | A1-10 | | — | C-4 | D-2 | — | 0.7 | ◯ | ◯ |
| | | 0.1 | | | 100 | 10 | | | | |
| | 16 | A1-11 | | — | C-4 | D-2 | — | 0.7 | ◯ | ◯ |
| | | 0.1 | | | 100 | 10 | | | | |
| | 17 | A1-12 | | — | C-4 | D-2 | — | 0.7 | ◯ | ◯ |
| | | 0.1 | | | 100 | 10 | | | | |
| Comparative | 1 | A1-1 | | 99.998 | C-1 | D-1 | 1,977 | 0.4 | Δ | Δ |
| Example | | 0.0025 | | | 100 | 4 | | | | |
| | 2 | A1-7 | | 99.8 | C-1 | D-1 | 2,052 | 0.35 | X | X |
| | | 0.2 | | | 100 | 4 | | | | |
| | 3 | A1-8 | | 99.8 | C-3 | D-2 | 2,128 | 0.5 | X | X |
| | | 0.2 | | | 100 | 8 | | | | |
| | 4 | A1-9 | | 99.8 | C-3 | D-2 | 2,128 | 0.5 | X | Δ |
| | | 0.2 | | | 100 | 8 | | | | |
| | 5 | | A2-4 | 99.975 | C-1 | D-1 | 1,986 | 0.35 | X | X |
| | | | 0.025 | | 100 | 4 | | | | |
| | 6 | A1-7 | | 99.8 | C-2 | D-1 | — | 0.5 | X | X |
| | | 0.2 | | | 100 | 4 | | | | |
| | 7 | A1-8 | | 99.8 | C-4 | D-2 | — | 0.6 | X | X |
| | | 0.2 | | | 100 | 8 | | | | |
| | 8 | | A2-4 | 99.875 | C-4 | D-1 | — | 0.6 | X | X |
| | | | 0.025 | | 100 | 6 | | | | |
| | 9* | A1-1 | | 99.9 | C-1 | D-1 | 2,014 | 0.4 | X | X |
| | | 0.1 | | | 100 | 4 | | | | |

*no UV irradiation

### Evaluation Method

Evaluation of test items and rating of results are as follows.

### (1) Peeling Force

A solvent type primer composition was coated onto a PET film of 40 μm thick in a coating weight of 0.005 g/m² as solids by means of a bar coater, exposed to UV radiation from two 80-W UV lamps at a line speed of 40 m/min in an integral dose of 50 mJ/cm², and heat treated in a hot air circulating dryer at 80° C. for 10 seconds, yielding a primed film. A solvent type release silicone composition consisting of components (C) to (F) was coated onto the primed film in a coating weight of 0.5 g/m² as solids and heat treated in a hot air circulating dryer at 100° C. for 30 seconds until a cured coating was formed, obtaining a test separator.

The separator was allowed to stand at 25° C. and 50% RH for one day, after which a solvent type acrylic pressure-sensitive adhesive (Oribain BPS-5127, Toyo Ink Mfg. Co., Ltd.) was coated onto the cured coating surface and heat treated at 100° C. for 3 minutes. Next, a PET film of 40 μm was laid on the treated surface, pressed by rolling once back and forth a roller of 2 kg, and aged at 25° C. for 20 hours. The sample was cut into a strip of 5 cm wide. Using a tensile tester, the force (N) required to peel the overlying PET film from the separator at an angle of 180° and a pull rate of 0.3 m/min was measured as adhesive strength. The tester used was autograph DCS-500 (Shimadzu Mfg. Co., Ltd.).

A solventless primer composition was coated onto a PET film of 40 μm thick in a coating weight of 0.005 g/m² as solids by means of an IR tester. The coating was UV irradiated under two 80-W UV lamps at a line speed of 40 m/min to an integral dose of 50 mJ/cm² and heat treated in a hot air circulating dryer at 80° C. for 10 seconds, yielding a primed film. A solventless release silicone composition consisting of components (C) to (E) was coated onto the primed film to a coating weight of 0.5 g/m² as solids by means of an IR tester and heat treated in a hot air circulating dryer at 120° C. for 30 seconds until a cured coating was formed. The subsequent process was the same as above, obtaining a test separator which was similarly evaluated. It is noted that the coating area was A4 size, and the transfer amount of primer liquid was 0.001 μL and the transfer amount of overcoating liquid was 0.1 μL.

### (2) Adhesion

A PET film (40 μm) substrate separator prepared as in (1) and another separator prepared as in (1) using a corona-treated OPP film (40 μm) as the substrate were aged under predetermined conditions. After a certain aging period (days), the separator was examined whether the coating surface became hazy and rubbed off when the surface of the cured coating was rubbed with the finger.

The sample which showed haze or rub-off after aging at 40° C. and 80% RH for one day was rated poor (X). The sample which showed haze or rub-off after aging at 40° C. and 80% RH for 3 days was rated fair (Δ). The sample which did not show haze or rub-off even after aging at 40° C. and 80% RH for one month was rated good (◯). The sample which did not show haze or rub-off even after aging at 60° C. and 90% RH for one month was rated excellent (⊚).

Japanese Patent Application No. 2010-107227 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A primer silicone composition which is, on use, coated on a paper or plastic film substrate and exposed to UV to form a primer layer which will be overlaid with a cured coating of a release silicone composition to form a release paper or film, the primer silicone composition comprising
(A) an adhesion-providing component which is
(A1) an organopolysiloxane containing at least two silicon-bonded alkenyl-containing substituent groups in a molecule, having an alkenyl content of 0.3 to 2.0 mol/100 g, and having a structure that two siloxane units in which the alkenyl-containing substituent group is bonded to silicon atom are linked directly or via up to 3 intervening siloxane units in which said substituent group is not bonded to silicon atom, the organopolysiloxane having a viscosity of less than 0.04 Pa-s at 25° C., and/or
(A2) a compound containing in a molecule at least one substituent group of 2 to 10 carbon atoms having a carbon-carbon unsaturated bond (double or triple bond) as functionality and at least one substituent group having a group capable of addition reaction and/or condensation reaction with an alkenyl and/or SiH group, and (B) an amount of an optional organic solvent.

2. The primer silicone composition of claim 1 wherein component (A1) is an organopolysiloxane represented by the compositional formula (1) having a structure of the general formula (2), and having an average degree of polymerization of 2 to 50, 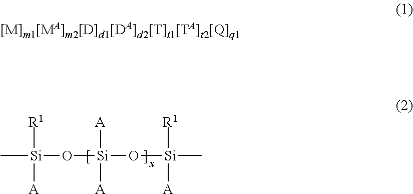
wherein R¹ is an alkenyl-containing substituent group of 2 to 10 carbon atoms, A is R² or a siloxane residue bonded via an oxygen atom and selected so as to meet formula (1), two A groups connected to one silicon atom may form a cyclic structure as —O(SiR²₂O)_{y}—, R² is a substituted or unsubstituted monovalent hydrocarbon group of 1 to 10 carbon atoms, x is an integer of 0 to 3, y is an integer selected such that the organopolysiloxane of formula (1) may have an average degree of polymerization of 2 to 50,
M, M^{A}, D, D^{A}, T, T^{A}, and Q are siloxane units as defined below, O_{1/2} denoting that adjacent siloxane units are linked via an oxygen atom,
M and M^{A} each are: 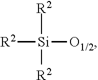
with the proviso that at least one R² in M^{A} is R¹,
D and D^{A} each are: 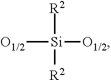
with the proviso that at least one R² in D^{A} is R¹,
T and T^{A} each are: 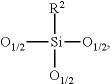
with the proviso that R² in T^{A} is R¹,
Q is: 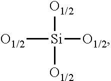
m1, m2, d1, d2, t1, t2, and q1 are numbers satisfying the equations:
t1+t2+2×q1≦m1+m2≦2+t1+t2+2×q1
0≦d1+d2≦48, 0≦t1+t2≦30, 0≦q1≦20,
0.25≦(m2+d2+t2)/(m1+m2+d1+d2+≦t1+t2+q1)≦1.

3. The primer silicone composition of claim 2 wherein x in formula (2) is 0 or 1.

4. The primer silicone composition of claim 2 wherein component (A1) is a compound of linear or branched siloxane structure having the general formula (3) or (4): 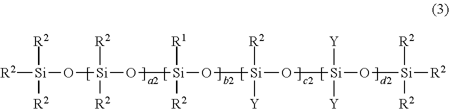
wherein R¹ and R² are as defined above, Y is a group of the following formula (3a): 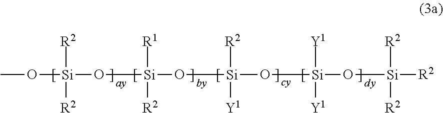
wherein R¹ and R² are as defined above, Y¹ is a group of the following formula (3b): 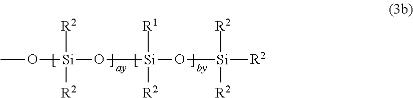
wherein R¹ and R² are as defined above,
a2, b2, ay, and by each are an integer of 0 to 48, c2 and cy each are an integer of 0 to 30, d2 and dy each are an integer of 0 to 20,
formulae (3), (3a) and (3b) each denote a random structure and include at least one structure that two siloxane units in which the alkenyl-containing substituent group R¹ is bonded to silicon atom are linked directly or via up to 3 intervening siloxane units in which R¹ is not bonded to silicon atom, 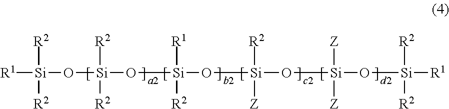
wherein R¹ and R² are as defined above, Z is a group of the following formula (4a): 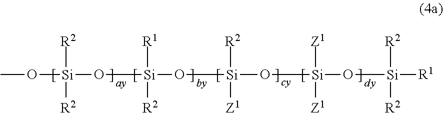
wherein R¹ and R² are as defined above, Z¹ is a group of the following formula (4b): 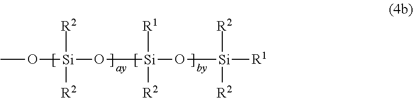
wherein R¹ and R² are as defined above,
a2, b2, ay, and by each are an integer of 0 to 48, c2 and cy each are an integer of 0 to 30, d2 and dy each are an integer of 0 to 20,
formulae (4), (4a) and (4b) each denote a random structure and include at least one structure that two siloxane units in which the alkenyl-containing substituent group R¹ is bonded to silicon atom are linked directly or via up to 3 intervening siloxane units in which R¹ is not bonded to silicon atom.

5. The primer silicone composition of claim 2 wherein component (A1) is a compound of cyclic siloxane structure having the general formula (5): 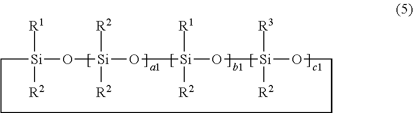
wherein R¹ and R² are as defined above, R³ is a substituent group having an OH or SiH group as functionality or a substituted or unsubstituted monovalent hydrocarbon group of 1 to 10 carbon atoms free of aliphatic unsaturation, a1 is 0 or 1, b1 is an integer of 1 to 6, c1 is an integer of 0 to 5, and a1+b1+c1 is an integer of at least 2.

6. The primer silicone composition of claim 1 wherein in component (A2),
the substituent group having a carbon-carbon unsaturated bond (double or triple bond) is a substituent group having alkenyl, alkynyl, acryloyloxy or methacryloyloxy, and
the substituent group having a group capable of addition reaction and/or condensation reaction with an alkenyl and/or SiH group is a substituent group having a SiH, OH or alkenyl group as functionality.

7. The primer silicone composition of claim 1 wherein in component (A2), the substituent group having a carbon-carbon unsaturated bond (double or triple bond) is a substituent group of 2 to 10 carbon atoms having alkynyl, acryloyloxy or methacryloyloxy, and the substituent group having a group capable of addition reaction and/or condensation reaction with an alkenyl and/or SiH group is a substituent group having a SiH, OH or alkenyl group as functionality.

8. The primer silicone composition of claim 1 wherein component (A2) is a compound containing a divalent structural unit having the general formula (6-1), a compound containing divalent structural units having the general formulae (6-2) and (6-3), a compound of cyclic structure having the general formula (7-1), or a compound of cyclic structure having the general formula (7-2): 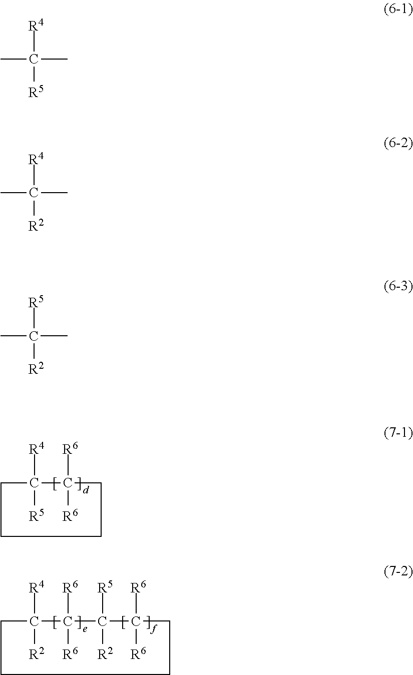
wherein R² is a substituted or unsubstituted monovalent hydrocarbon group of 1 to 10 carbon atoms, R⁴ is a substituent group of 2 to 10 carbon atoms containing alkynyl, acryloyloxy or methacryloyloxy, R⁵ is a substituent group having an OH, SiH or alkenyl group as functionality, R⁶ is hydrogen, a saturated hydrocarbon group of 1 to 10 carbon atoms or aromatic group, the same group as R⁴, or the same group as R⁵, d is 4 to 10, and e+f is 3 to 9.

9. The primer silicone composition of claim 1 wherein the release silicone composition is of addition and condensation reaction cure type.

10. The primer silicone composition of claim 1, further comprising some or all of components of the release silicone composition.

11. A treated paper or film substrate obtained by coating a surface of a paper or film substrate with the primer silicone composition of claim 1 and exposing to UV radiation, wherein the treated surface will be overlaid with a cured coating of a release silicone composition to form a release paper or film.

12. A release paper or film comprising the treated paper or film substrate of claim 11 and a release silicone composition coated and cured to the treated substrate surface.
